(19) United States
(12) Patent Application Publication
(10) Pub. No.: US 2008/0069026 A1
(43) Pub. Date: Mar. 20, 2008

(54) Repeater for WUSB applications

(75) Inventors: Man Chi Chan, Hong Kong (CN); Chi Fai Jack Tang, Hong Kong (CN); Quan Long Din, Hong Kong (CN)

Correspondence Address: BUCHANAN, INGERSOLL & ROONEY PC, POST OFFICE BOX 1404, ALEXANDRIA, VA, 22313-1404, US

(73) Assignee: Hong Kong Applied Science and Technology Research Institute Co., Ltd., Hong Kong (CN)

(21) Appl. No.: 11/520,608

(22) Filed: Sep. 14, 2006

(51) Int. Cl. H04J 3/08

(52) U.S. Cl. 370/315

(57) ABSTRACT

A repeater for connecting a host and a device in a WUSB environment, the repeater comprising:
host interfacing means for establishing a secure wireless data communication channel for data communication with a host,
device interfacing means for establishing a secure wireless data communication channel for data communication with a device,
data buffer for storing data for subsequent onward transmission to either said host or said device, and
scheduler for scheduling timing of onward transmission of data from said data buffer to either said host or said device.

### FIELD OF THE INVENTION

The present invention relates to repeaters, and more particularly, to repeaters for application in wireless universal serial bus (WUSB) environments.

### BACKGROUND OF THE INVENTION

Repeaters are commonly employed to extend the communication range between a transmitter and a receiver. In a typical WUSB environment, the communication range between a WUSB host and a WUSB device is usually limited to be in the region of 3-10 meters, due largely to FCC (Federal Commission of Communications) Regulations. The communication range is even shorter when there is an obstacle between a WUSB host and a WUSB device. Hence, it is desirable to provide a repeater to extend the communication range between a WUSB host and a WUSB device.

Unlike conventional wireless repeaters, the host in a WUSB environment is a dominant component which defines essentially all system operation parameters and is in effective control of the system operation and the device is a more passive component which reacts to requests of the host. A device which can operate as a repeater in a WUSB operational environment must therefore be a device with intelligence which has to operate under a set of severe constraints imposed by the WUSB standards of the time being, and not merely a passive repeater as in the case of most wireless repeaters.

Hence, it will be desirable if there can be provided a repeater with adequate intelligence for use in a WUSB environment for connecting between a WUSB host and at least a WUSB device.

### SUMMARY OF THE INVENTION

According to the present invention, there is provided a repeater for connecting a host and a device in a WUSB environment, the repeater comprising host interfacing means for establishing a secure wireless data communication channel for data communication with a host, device interfacing means for establishing a secure wireless data communication channel for data communication with a device, data buffer for storing data for subsequent onward transmission to either said host or said device, and scheduler for scheduling timing of onward transmission of data from said data buffer to either said host or said device.

According to another aspect of this invention, there is provided a method for relaying data packets between a host and a device through a repeater in a WUSB environment, the method comprising establishing a secured wireless data communication channel for data communication with said repeater and said host, establishing a secured wireless data communication channel for data communication with said repeater and said device, storing data in a data buffer of said repeater for subsequent onward transmission to either said host or said device, and scheduling timing of onward transmission of data from said data buffer to either said host or said device.

According to yet another aspect of this invention, there is provided a WUSB system comprising a host, a device and at least one repeater.

Preferably, scheduling information on timing of onward transmission from said buffer to either said host or said device is contained in data received through said host interfacing means.

Preferably, the repeater comprises a control means for onward transmission of data to said host or said device.

Preferably, said data comprises host identification information of said host.

Preferably, said repeater comprises a transceiver means for operating on a plurality of physical channels, said scheduling information on timing of onward transmission from said buffer to either said host or said device is contained in data received through said host interfacing means.

Preferably, said scheduler comprises means for reserving a first set of time slots for data communication between said repeater and said host, and for reserving a second set of time slots for data communication between said repeater and said device, the time slots in said first and second sets of time slots being overlapping.

Preferably, said scheduler comprises means for reserving a first set of time slots for data communication between said repeater and said host, and for reserving a second set of time slots for data communication between said repeater and said device, the time slots in said first and second sets of time slots being non-overlapping.

Preferably, said first and said second set of time slots are within a same superframe.

Preferably, said host interfacing means is configured to communicate as a device for establishing a communication link with said host.

Preferably, said device interfacing means is configured to communicate as a host for establishing a communication link with said device.

Preferably, said repeater is configured to communicate as a device for establishing a communication link with said host, and said repeater is configured to communicate as a host for establishing a communication link with said device.

Preferably, said host interfacing means comprises a wireless transceiver operable on a plurality of physical channels, said wireless transceiver operating in a single physical channel for establishing a communication link with said host.

Preferably, said host interfacing means is configured to respond to polling of said host by transmitting a data packet on said single physical channel.

Preferably, said device interfacing means comprises a wireless transceiver operable on a plurality of physical channels, said wireless transceiver operating on a single physical channel when establishing a communication link with said device.

Preferably, said device interfacing means is adapted for connection with a plurality of devices.

Preferably, said repeater further comprises means for uploading control data to said host, said control data are utilized by said host for controlling said repeater for data communication with said device.

Preferably, timing of onward transmission of data from said data buffer to said device is determined from contents of data received through said host interfacing means.

Preferably, wherein an acknowledgement or a handshake signal is sent by said repeater to said host after stored data have been transferred from said repeater to said device.

Preferably, said device is associated with said host through said repeater, association between said host and said device comprises a first association between said host and said repeater, and a second association between said host and said device via said repeater.

Preferably, said repeater is associated as a WUSB device to said host, and said repeater behaves as a WUSB host to associate with said device under control of said host.

Preferably, stored data are transmitted to said data buffer of said repeater upon receipt of a data request instruction of said host by said repeater, said stored data being transferred from said repeater to said host upon a successful polling of said repeater by said host.

Preferably, said repeater transmits an interrupt request to said host after data for forwarding to said host have been stored in said buffer, said data being transferred from said repeater to said host after a successful polling of said repeater by said host.

### BRIEF DESCRIPTION OF THE DRAWINGS

Preferred embodiments of the present invention will be explained in further detail below by way of examples and with reference to the accompanying drawings, in which:

FIG. 1 is a schematic block diagram depicting a WUSB system with a repeater of this invention,

FIG. 2 shows a schematic equivalent circuit block diagram of a repeater of this invention,

FIG. 3 shows a functional block diagram of the repeater of this invention,

FIG. 4 shows a superframe illustrating time slot reservation of the various components of the WUSB system of FIG. 1,

FIG. 5 illustrates schematically an exemplary sequence of connection procedures between a repeater of this invention and a WUSB host,

FIG. 6 illustrates schematically a sequence of operations for connection between a repeater of this invention and a WUSB device and the subsequent establishment or control data flow between the host, the device and the repeater,

FIG. 7 illustrates schematically communication data flow between a WUSB host and a WUSB device through the intermediary of a WUSB repeater,

FIG. 8 illustrates schematically an exemplary WUSB repeater control function configuration at a WUSB host,

FIG. 9 illustrates schematically association of a device through a WUSB repeater of this invention,

FIG. 10 shows a block diagram illustrating a WUSB repeater with two transceivers,

FIG. 11 is a schematic diagram illustrating a WUSB repeater system with two WUSB devices,

FIG. 12 illustrates a WUSB repeater system comprising two WUSB repeaters in cascade,

FIG. 13 shows an exemplary frame payload of a typical WUSB packet,

FIG. 14 illustrates exemplary security enumeration procedures through a WUSB repeater of this invention, and

FIG. 15 illustrate schematically mutual authentication and key exchange procedures through a WUSB repeater of this invention.

### DETAILED DESCRIPTION OF THE PREFERRED EMBODIMENTS

In this specification, reference to the term WUSB should include references to WUSB and WUSB compatible wherever the context is appropriate or permits, and without loss of generality.

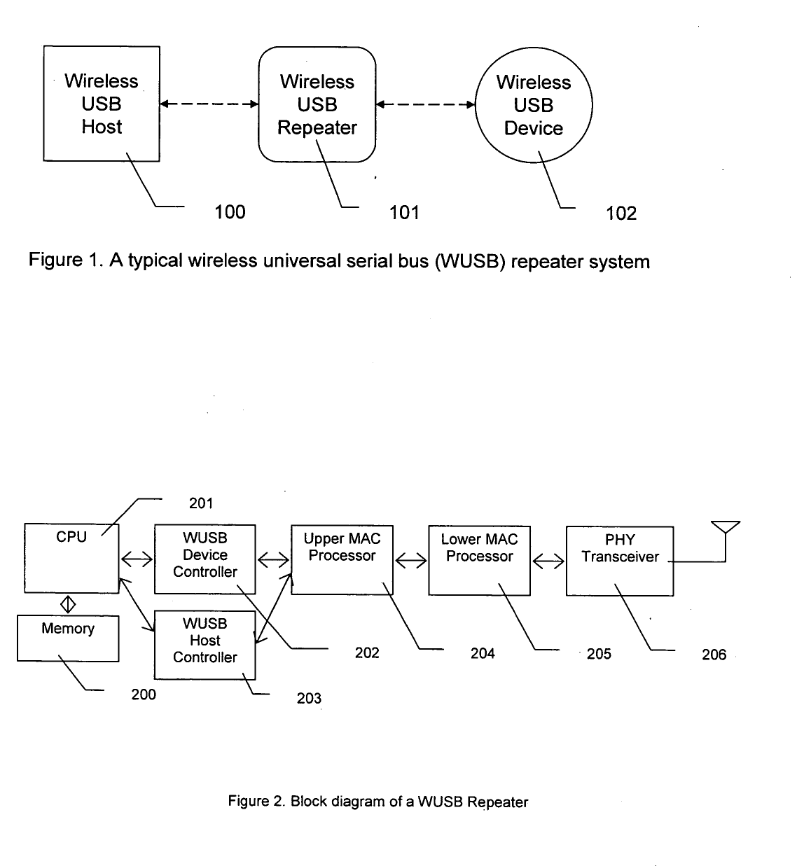

An exemplary system of this invention comprising a WUSB compatible host 100, a WUSB compatible repeater 101 and a WUSB compatible device 102, is depicted in FIG. 1. In this exemplary system, it is assumed, for the sake of simplicity and without loss of generality, that the WUSB device 102 is out of the communication range of the host 100 so that the host 100 cannot communicate with the device 102 directly, and that the repeater 101 is within the communication range of both the host 100 and the device 102 so that it can communicate with the host 100 and the device 102 directly. The repeater 102 is provided to facilitate communication between the device 102 and the host 100 to overcome the communication range limit due to the host 100 and the device 102.

### Repeater Functional Block Diagram

To support data communication between a WUSB host and a WUSB. device, the repeater would consist of at least four endpoints, namely, a default control endpoint, an interrupt endpoint, a bulk OUT endpoint and a bulk IN endpoint. These endpoints are standard WUSB endpoints which have the same transfer characteristics as described in “Wireless Universal Serial Bus Specification (Revision 1.0), 12 May 2005 by Universal Serial Bus Implementers Forum (USBIF), including all published errata, which is incorporated herein by reference.

Specific functions of these endpoints in the WUSB repeater are as follows:
The default control endpoint is adapted for receiving control requests from a WUSB host and for sending responses to a WUSB host.
The interrupt endpoint is adapted for sending the WUSB host transfer completion notifications, device connect/disconnection notifications and link status related notifications in an asynchronous manner.
The bulk OUT and bulk IN endpoints are means for moving data packets from the WUSB host, across the repeater, to the target device, and for moving data packets from the target device through the repeater to the WUSB host.

The above endpoints are necessary for the repeater to perform data relay function and can be configured into one or more logical WUSB interfaces for better control management. Of course, more endpoints can be added to support additional control functions without loss of generality.

A block diagram of an exemplary WUSB repeater of this invention is depicted in FIG. 2. The repeater comprises a storage means (e.g., RAM) 200, a controller (CPU) 201, a WUSB Device Controller 202, a WUSB Host Controller 203, a Upper MAC Processor 204, a Lower MAC Processor 205, and a PHY Transceiver 206. The main functions of these functional units are described in more detail below.

### PHY Transceiver 206

The PHY transceiver is adapted to receive and transmit radio frequency signals, and to convert radio-frequency signals into base-band digital outputs and vice versa.

### Lower MAC Processor 205

The lower MAC processor 205 is adapted to perform the following functions.
computes control fields such as CCM, CRC-32, AES-128
manages keys and encryption processing
controls packet transmission and reception over PHY transceiver
controls inter-packet timing
controls radio transmission power

### Upper MAC Processor 204

The upper MAC is adapted to perform the following.
decodes filtering,
controls packet transmission timing
controls the Lower MAC Processor 205 to perform channel selection and scanning

### WUSB Host Controller 203

The WUSB host controller 203 is adapted to perform the following.
Generates WUSB control management packets
Schedules and controls WUSB transactions to the WUSB device
Handles packet retries
Handles time-critical control and command packets and status processing
Starts up and controls WUSB channel
Provides data and control interfaces for the CPU 201 to communicate with individual device endpoints

### WUSB Device Controller 202

It is adapted to perform the following.
Decodes WUSB control management packets
Handles packet retries
Handles time-critical control and command packets and status processing
Handles WUSB transactions on the repeater's endpoints
Provides data and control interfaces for the CPU 201 to communicate with the host via the repeater's endpoints

### CPU 201

It is used to perform the following
Manages packet transfer buffers
Works with the WUSB Device Controller 202 to handle communications with the WUSB host
Works with the WUSB Host Controller 203 to handle communications with the WUSB device
Controls UWB radio platform operations
Performs the said repeater control functions
Processes non-time-critical WUSB controls
Manages host connection setup and device connection setup
Handles data transfers between the WUSB host and the WUSB device and manages the transfer status

### Memory 200

It is used to store application image and data for operations.

### Repeater CPU Functional Block Diagram

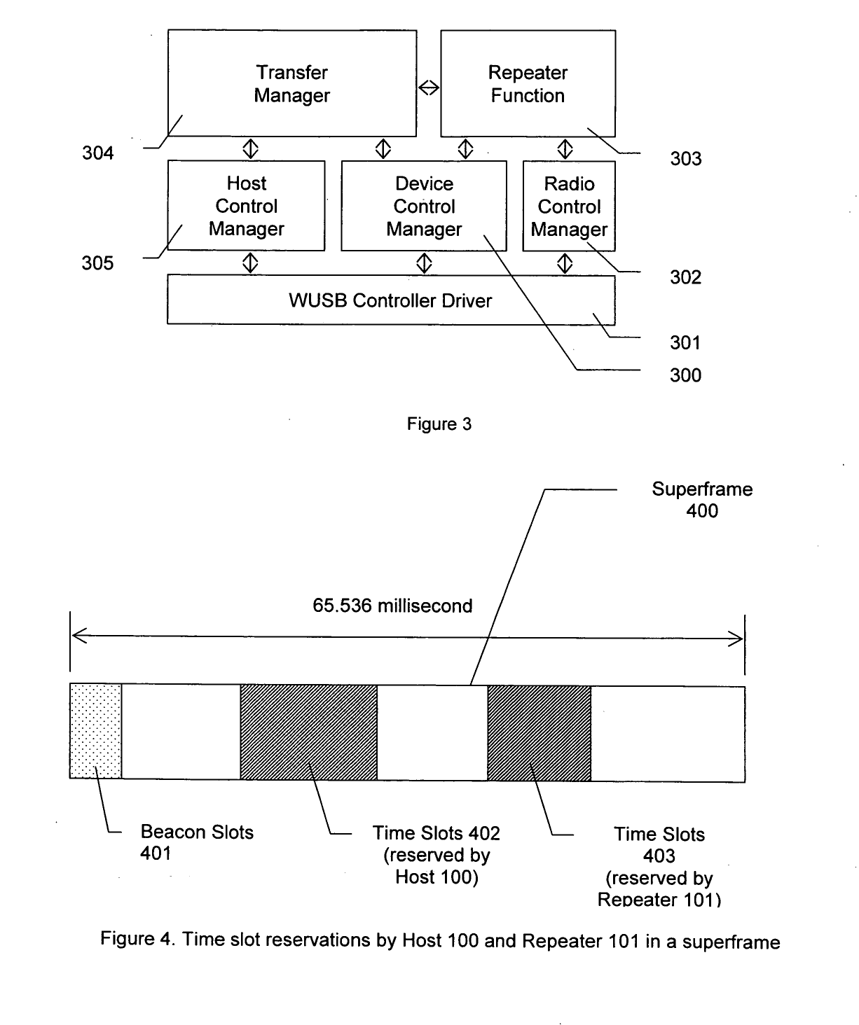

A functional block diagram of the WUSB repeater CPU is depicted in FIG. 3. These function blocks are implemented by the CPU 201 to provide the required repeater functions. The basic functions of these software function blocks are as follows:

### WUSB Controller Driver 301

It is adapted to interface the WUSB Device Controller 202 and WUSB Host Controller 203 and provides a means for the other software function modules to communicate and control them
It initializes the WUSB Device Controller 202 and WUSB Host Controller 203 and configures them during power up or upon software control

### Host Control Manager 305

It is adapted to manage connection and communications with the WUSB device connected to the repeater
It is responsible for handling all the WUSB transactions to communicate with the WUSB device
It is responsible for handling the connection setup related procedures and operations with the WUSB device
It interfaces the Transfer Manager 304 to handle data transfers to or from individual device endpoints
It controls transactions schedules to the connected WUSB device

### Device Control Manager 300

It is adapted to handle communications with the WUSB host on the specified repeater endpoints
It is responsible for initializing the repeater endpoints and controls them
It performs security enumeration and device enumeration with the WUSB host
It decodes the control requests received on the control endpoint and responses them over the control endpoint
It works with the Repeater Function 303 to provide the said repeater functions
It moves data from the bulk OUT endpoint to the Transfer Manager 304 and passes data from the Transfer Manager 304 to the bulk IN endpoint in order to control the data communications with the WUSB device

### Radio Control Manager 302

It is adapted to control the UWB radio platform of the repeater by interfacing with the WUSB Controller Driver 301
It is responsible for handling link status related processing
It interfaces with the Repeater Function 303 to execute the received requests from the host and to provide the said repeater functions

### Transfer Manager 304

It is responsible for managing data buffers to handle packet transfers between the WUSB host and the individual endpoints on the WUSB device
It delivers the data received from the bulk OUT endpoint on the Device Control Manager 300 to the assigned buffer queues.
It passes the data received from the Host Control Manager 305 to the bulk IN endpoint on the Device Control Manager 300 via the assigned buffer queues
It provides an interface for the Host Control Manager 305 to access the buffer queues for communications with the WUSB device
It interfaces with the Repeater Function 303 to control and manage buffer assignment for handling individual data transfers

### Repeater Function 303

It is adapted to provide an interface for the Device Control Manager 300 to pass the received control request from the host on the control endpoint
It processes the received control request from the control endpoint on the Device Control Manager 300 and returns the execution results to the Device Control Manager 300.
It controls the Transfer Manager 304 to configure its buffers into logical buffer queues and assign the logical buffer queues to handle transfers to individual endpoints on the WUSB device
It controls the Radio Control Manager 302 to control the UWB radio of the repeater to operate the communication channel to the WUSB device
It is responsible for handling self-beaconing function of the repeater via the help of the Radio Control Manager 302

An overview of data transfer across the repeater 400 will be described below with reference to FIG. 4.

FIG. 4 shows a typical superframe 400 with exemplary time slots allocation depicting the time slots reserved by each of the components of the system when the WUSB host 100 is in communication with the WUSB device 102 via the WUSB repeater 101. In each superframe 400, the WUSB host 100 will reserve time slots 402 and then communicate with the WUSB repeater 101 via these time slots. Likewise, the WUSB repeater 101 will reserve time slots 403 and will then use the time slots for communication with the device 102. In order to transfer data packets to the device 102, the WUSB host 100 will first send the data packets to the repeater 101 within the time slots 402. The repeater 101 will then relay the data packets to the device 102 within its own reserved slots 403. Likewise, to facilitate transfer of data packets from the device 102 to the host 100, the repeater 101 will first poll the device 102 during time slots 403. If the polling is successful, the designated data packets will be transferred from the device 102 to the repeater. After the data packets have been transferred to the repeater 101, and upon successful polling of the repeater 101 by the host 100, the data packets will be forwarded to the host 100 during time slots 402 of a subsequent superframe. Under the prevalent WUSB protocols, the host 100 will repeatedly poll the repeater 101 during the time slots 402 of a superframe in order to ascertain whether there are data packets available. Similarly, the repeater 101 will repeatedly poll an assoia ed device 102 during its reserved time slots 403 in a superframe to monitor whether there are data packets available in the device 102 which are ready for transmission.

The above illustrates an overview of an exemplary data flow under which a host 100 can communicate with a device 102 Via a repeater 101 over a common PHY channel in a polled TDMA manner. Further details on the manner by which connection and data transfers between the host and the device are accomplished via the repeater will be described further below.

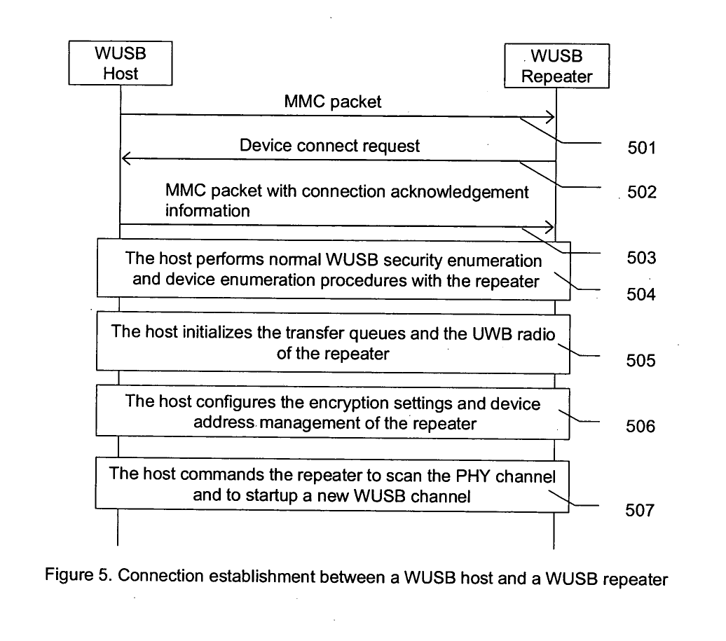

An exemplary sequence of operations leading to subsequent association or connection between the WUSB host 100 and the WUSB repeater 101 will be described below with particular reference to FIG. 5.

In the first example, it will be assumed for the sake of convenience that the host 100, the repeater 101, and the device 102 have been successfully associated or connected previously. In addition, it is assumed that the various system components initially operate on the same physical channel PHY A, although the system components can operate in physical channels PHY A, PHY B, and PHY C to be described in other examples. In such a case, security enumeration and device enumeration procedures between the various system components have been successfully performed, and the necessary connection and/or association data are stored or maintained in the various components, that is, the host 100, the repeater 101, and the device 102.

Initially, the system does not have a repeater in operation. This can be modelled by assuming that the repeater 101 is in a “power off” state, while the host 100 and the device 102 are in a “power on” state. When the host 100 attempts to make connection with the device 102, the host 100 will firstly reserve time slots 402 in each superframe on the channel PHY A and then send out MMC packets repeatedly during the reserved time slots 402. Although the device 102 also listens on channel PHY A, no communication between the host 100 and the device 102 could be made because the host and the device are out of communication range. As a result, the device 102 cannot hear the MMC packets sent by the host 101 on PHY channel A, and the host 100 cannot detect the device 102.

To establish the repeater linked connection between the host and the device, the repeater 101 will be powered on first. After the repeater has been powered on and initialised, the repeater will listen on channel PHY A for a prescribed period for MMC packets and starts a “scan timeout” timer. In the meantime, the host will continue to transmit MMC packets, as depicted at step 501 of FIG. 5. If a MMC packet is received before the timeout period, the repeater will operate to ascertain whether the MMC is from the host 100. Specifically, the MMC packet will be examined to ascertain whether it contains host information of a host which has been previously registered. If the source of the MMC is confirmed to be from a previously registered host, the repeater 101 has been associated with the host 100 before, and the host 100 would have the necessary connection information to complete the remaining connection setup operations. Upon successful connection, the repeater 101 will accept the MMC packet sent in step 501 and then retrieve the schedule information contained therein. Specifically, the schedule information will specify the time slots or intervals during which the repeater 101 is allowed to send a device connection request to the host.

In response, the repeater 101 will reserve a time slot within the specified time intervals and transmit a device connect request in step 502 to the host. Upon reception by the host of the device connect request sent by the repeater 101 at step 502, the effective presence of the repeater 101 is successfully detected by the host 100. The host will then send out MMC packets in step 503 with connection acknowledgement information contained therein. Based on the connection acknowledgement information contained within the MMC packet sent in step 503, the repeater 101 will configure its device address in order to prepare for subsequent receipt of control requests from the host 100. Next, the host 100 and the repeater 101 will go through the usual WUSB security enumeration and device enumeration procedures, as indicated in step 504. After that, the host 100 will send control requests in step 505 to the repeater 101 in order to initialize its buffer queues and its ultra-wide band (UWB) radio platform. Next, the host will send out control requests in step 506 to the repeater 101 to configure encryption settings and communication addressing settings of the repeater 101. Finally, the host 100 will send commands in step 507 to the repeater 101 to request the repeater 101 to scan the PHY A physical channel and to reserve time slots in each superframe to startup communication with the WUSB device. Throughout the above set of operational sequences, it will be appreciated that the repeater appears as a WUSB device to the host and the host treats the repeater as a WUSB device. After the enumeration procedures of 504 have been successfully completed, the repeater 101 will stop the scan timeout timer. If the enumeration procedures of step 504 fail before the scan timeout occurs, the repeater 101 will terminate the connection setup operations and listen again during the next superframe.

In operation steps 505, 506 and 507 described above, the host 100 will send a set of commands and control requests to the repeater 101 in order to configure the control and operation settings of the repeater 101. It will be appreciated that, as an alternative or as an option, the host 100 can also utilise a wire adapter (WA) and/or host wire adapter (HWA) class-specific control requests with the similar functions to control the repeater to perform the operation steps 505, 506 and 507. In response, the repeater will return the replies to these control requests following formats specified in the WA and HWA class. In this way, standard WUSB commands can be utilized and there is no need to define new or specific proprietary WUSB control requests or result codes for controlling the WUSB repeaters to perform the operation steps 505, 506 and 507.

Where the device 102 has not been associated previously, initial association procedures between the repeater and the host, and between the host and the device through the repeater will have to be performed. To associate the repeater 101 with the host 100, the Device Control Manager 300 will commence conventional association procedures. The association procedures are identical to the association procedures between a conventional WUSB host and a WUSB device, except with the repeater 101 appearing as a device to the host 100. Likewise, the Host Control Manager 305 will perform association procedures on behalf of the host with the device, and to the device the repeater is behaving as a host in conventional WUSB terms.

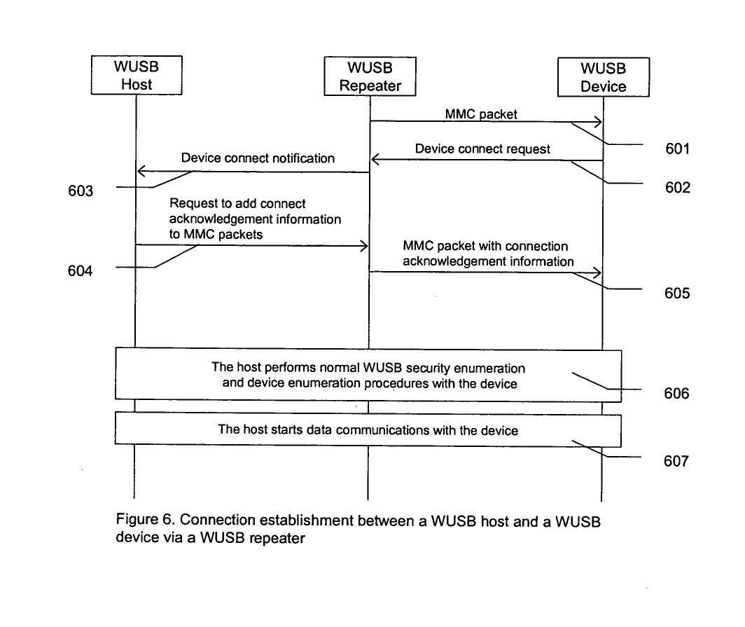

An exemplary sequence of steps for establishing a communication link between the repeater and the device will be described below with reference to FIG. 6.

After the host setup procedures have been completed successfully, the repeater 101 will prepare for communication with the device 102. Firstly, the repeater will reserve time slots 403 in each superframe. Next, the repeater 101 will generate MMC packets and then transmit the MMC packets on the physical channel during the reserved time slots 403, as depicted in step 601. The MMC packets generated by the repeater 101 will contain the same host information as that sent by the host 100 originally. Upon receipt of the MMC packets, the device 102 will examine the MMC packs to decide whether the host information carried by the MMC packet is matched to the known host 100. If the host information contains authentication or identification information of the known host, that is, a host which has been previously registered with the repeater (a “pre-registered host”), the device 102 will accept the MMC packet and retrieve the host information from the MMC packet. Thereafter, the device will return a device connect request to the repeater within the time interval specified by the schedule information of the MMC packet, as depicted in step 602. It will be appreciated from the above course of operation that the repeater effectively appears as a WUSB host to the device 102.

Upon receipt of the device connect request sent in step 602, the repeater 101 will respond by sending a device connect notification to the interrupt endpoint of the host 100, as depicted in step 603. With the receipt of the device connect notification by the host from the device, the host 100 will also receive the embedded device connect request, which is originated from the device 102. The host 100 will respond by sending a control request to the repeater 101, as depicted in step 604. The control request will request the repeater 101 to include “connect acknowledgement information” in its MMC packets for subsequent forwarding to the device 102 in step 605.

Similar to the procedures for association between the host 100 and the repeater 101, the device 102 will configure its device address after receipt of the MMC packets 605 from the repeater 101, so that the control request from the host 100 can be received during the forthcoming operations. To complete association, the repeater 101 will go through the usual WUSB security enumeration and device enumeration procedures with the device 102, as depicted in step 606. Upon successful security enumeration and device enumeration procedures between the repeater 101 and the device 102, the repeater would be in a position to begin communication with the device. Consequently, the host 100 will be in a position to begin data communication with the device 102 through the repeater 101 as an intermediary, as depicted more particularly in step 607.

In summary, during the security enumeration procedures 606, and the subsequent data communication exchanges of step 607 through the repeater 101, the host 100 will send transfer requests to the repeater 101 and to control the repeater 101 to forward data packets to the device 102 and/or to retrieve data packets from the device 102.

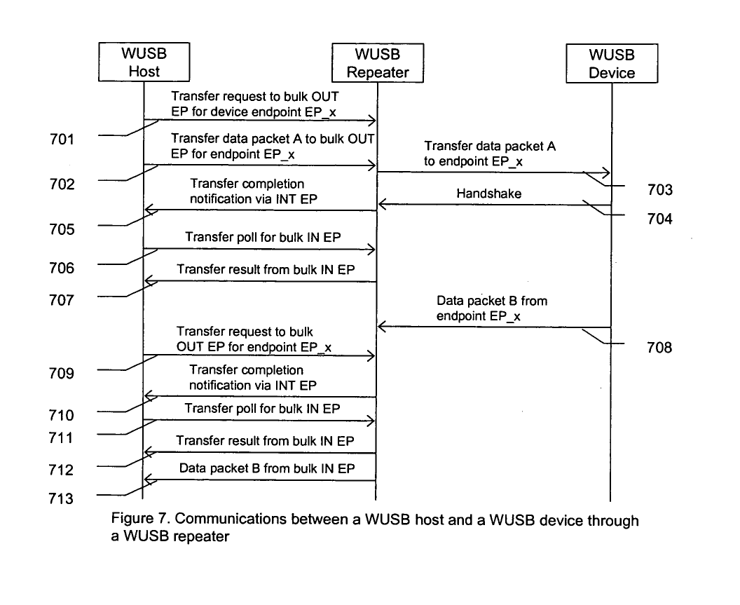

An exemplary sequence of data communications between the host and the device through the repeater will be explained in more detail below with reference to FIG. 7, in which an exemplary packet forward mechanism implemented by the repeater is depicted.

To cause transfer of a data packet (or a control request) A to the device 102, the host 100 will first send a transfer request (step 701) on the bulk OUT endpoint of the repeater 101. The transfer request will provide the repeater 101 with various information, (for example, data destination information), so that the repeater is informed of the ultimate destination when a packet is next sent to its bulk OUT endpoint from the host 100. In addition, other transfer information, for example, transfer direction (i.e., whether the transfer is for transfer towards the device or the host), transfer type (i.e., whether the transfer type is bulk, interrupt or isochronous), maximum packet size, transfer speed (e.g. 480 Mbps) and burst size, or the like will be sent.

In the instant example, the data destination information will inform the repeater that the next packet to be sent to its bulk OUT endpoint from the host 100 is destined the endpoint with address EP_x on the device having device ID DEV_ID. Next, the repeater 101 will look up from a logical buffer queue (designated as L), which is assigned for handling packets destined for the addressed device endpoint (DEV_ID, EP_x) and update the corresponding transfer information to its transfer descriptor, if appropriate or necessary.

It will be appreciated from the above, especially with reference to FIGS. 3 and 5, that each logical buffer queue has a transfer descriptor which provides information for the Transfer Manager 304 to work out transfer schedules for each endpoint on the device 102 in order to meet individual endpoint characteristics. In particular, assignment of the logical queue for device endpoint (DEV_ID, EP_x) is performed the first time when the repeater 101 has received a transfer request for this particular device endpoint. The logical buffer queues will have been initialized at operation step 505 when the host 100 configures the repeater 101 at the connection setup phase. The assignment of the logical buffer queue will be released when its addressed device endpoint is no longer active or there is no packets received from or to the addressed device endpoint within a prescribed period.

After the transfer request has been received by the repeater as a result of step 701, the repeater will have received the data packet A from the host 100. As specified by the transfer request 701, the repeater 101 is required to deliver this data packet A to the designated or assigned logical buffer queue L. Next, the repeater 101 will transmit the data packet Ato the device 102 within the time slots 403 already reserved according to the transaction schedules as specified in the MMC packets it generated, as depicted by step 703. Upon receipt of the data packet A, the device 102 will return a handshake packet, as depicted in step 704, and in accordance with the transmission schedule of the received MMC packet. After this, the repeater 101 will send a transfer completion notification packet to the host 100 over its interrupt endpoint, as depicted by step 705. Upon receipt of the transfer completion notification sent at step 705, the host 100 will schedule a transfer poll on the bulk IN endpoint of the repeater 101. In response to the polling, the repeater 101 will return a transfer success result via the bulk IN endpoint in accordance with the schedules set by the host 100 in its MMC packet, as depicted by step 707.

Assuming now that the device 102 has another data packet, or a request result packet, (say, packet B), on its endpoint with endpoint address EP_x, which is pending for transmission to the host 100. The device 102 will wait for the next transfer poll from the repeater with an endpoint address EP_x. As noted above, the Transfer Manager 304 will work with the Host Control Manager 305 to schedule transfer polls on the device 102. Thus, the scheduling is based on transfer information of the logical queues assigned for its endpoints. After the transfer poll on the endpoint EP_x has been received, the device 102 will in accordance with the transmission schedule specified in the MMC packets for the endpoint EP_x transfer the packet B to the repeater 101, as depicted by step 708. Upon receipt of the packet B, the repeater 101 will place the packet B into the logical buffer queue which has been assigned for this device endpoint address (DEV_ID, EP_x) for consequent forwarding to the host.

After the packet B has been placed on the logical buffer queue, the repeater will wait for the next transfer request poll from the host polling for the device endpoint with the specific address (DEV_ID, EP_x). Upon receipt of the transfer request, and as depicted by step 709, the repeater 101 will send a transfer completion success notification to the host 100 via the interrupt endpoint, as depicted by step 710. Next, the host 100 will send a transfer poll on the bulk IN endpoint of the repeater 101, as depicted by step 711. In response, the repeater will return a transfer success result packet, as depicted by step 712. Finally, the data packet B will be retrieved from the logical queue addressed (DEV_ID, EP_x) and forwarded to the host 100 in accordance with the transmission schedule specified in the MMC packets generated from the host 100, as depicted by step 713. It will be appreciated that, in this specific example, the host 100 is required to schedule transfer polls for the endpoints on the repeater 101 and the device 102 according to their respective endpoint characteristics.

The repeater can also operate an alternative scheme for forwarding data packets from the device to the host. An example of such an alternative scheme will be described below with reference to FIG. 7, but with step 709 omitted. In this alternative scheme, the host 100 does not send a transfer request to the repeater 101 for any active data IN endpoints, such as bulk IN endpoints or isochronous IN endpoints. After the repeater 101 has received a data packet (say, data packet B) (or request result) from the endpoint EP_x on the device 102, it will send a transfer completion notification to the host 100 via its interrupt endpoint. Upon receipt of the transfer completion notification, the host 100 will schedule a transfer poll on the bulk IN endpoint, as depicted in step 711. In response, the repeater 101 will return the transfer success result at step 712 and the data packet B (or request result) received from the device 102 will be forwarded to the host 100 according to transmission schedules in the MMC packets from the host 100, as depicted by step 713. In this alternative data forwarding scheme, the transmission step 709 is omitted and the host 100 is not required to schedule transfer polls for the endpoints of the device 102. Consequently, transmission power and the number of transmissions involved can be reduced, thereby making the transfer process even more efficient.

Likewise, the host 100 can make use of the wire adapter (WA) class-specific transfer request command to inform the repeater 101 about the transfer information and request the repeater 101 to assign logical queues for handling the various forthcoming data transfers, and to perform operation steps 505, 506 and 507. The repeater 101 will operate in accordance with the formats specified in the various WUSB standards to respond to those WA class specified requests. Hence, there is no need to define any proprietary control requests or commands for handling the data transfer operations.

In a preferred embodiment, the system components, namely, the host, the repeater and the device can operate in any one of a plurality of physical channels, namely, say, PHY A, PHY B, or PHY C. Assuming for the sake of convenience that the host is initially operating on PHY A, the host will repeatedly and sequentially send MMC packets on PHY A, PHY B and PHY C during the reserved time slots 402. By the device electing to respond through a specific physical channel, for example, PHY B, and not through other physical channels, the repeater could be the de facto commander with power to determine the preferred physical channel of communication, even though the host is the dominant component in a conventional WUSB environment.

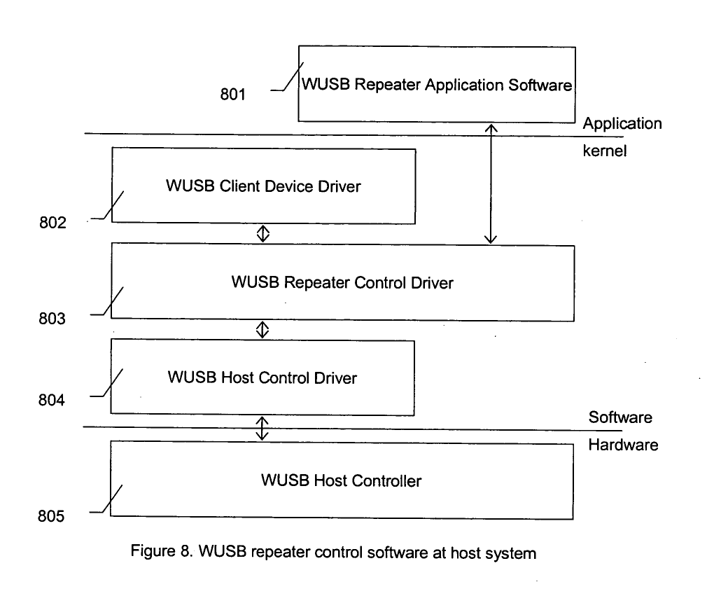

An exemplary control configuration of the host 100 for implementing control of a connected host controller for communicating with the device 102 via the repeater 101 is depicted in FIG. 8. The control configuration can be implemented for running on a computer or on as an embedded computer system.

The configuration of FIG. 8 depicts a WUSB Host Control Driver 804, which is adapted for facilitating communication with the WUSB Host Controller 805. Specifically, the WUSB Host Controller 805 is adapted to provide data transfer capability for the WUSB device drivers to communicate with WUSB devices. The WUSB Host Control Driver 804 has software interface functions that compile with the existing USB bus driver interface like the Windows USB bus driver interface, so it can work with the existing WUSB device drivers properly. The WUSB F Repeater Control Driver 803 and the WUSB Client Device Driver 802 are examples of WUSB device drivers. The WUSB Host Control Driver 804 is also responsible for handling all the WUSB device management and configuration, including the connection setup procedures 501, 502, 503 and 504, and controlling all the WUSB data transfers in the system.

The WUSB Repeater Control Driver 803 is adapted for communication with the WUSB Host Control Driver 804 via the USB bus driver interface during operation. This WUSB Repeater Control Driver 803 is adapted to configure and control the repeater 101 through the WUSB Host Control Driver 804, for example, for performing the operation steps 505, 506 and 507. Moreover, the WUSB Repeater Control Driver 803 is also responsible for configuring the device which is connected to the repeater and for managing all data transfers between the repeater and the device. For instance, the WUSB Repeater Control Driver 803 can control the repeater 101 to go through the procedure steps 605, 606 and 607 to connect and then communicate with the device 102. Similar to the WUSB Host Control Driver 804, the WUSB Repeater Control Driver 803 comprises software interfaces which are compatible with the existing USB bus driver interface. The WUSB Repeater Control Driver 803 uses this interface to communicate with the existing WUSB device drivers and provides the existing WUSB device drivers with necessary data transfer capability to communicate with the devices connected to the repeater. In this example, the WUSB Client Device Driver 802 can utilize this driver interface to communicate with the device 102 through the repeater 101, noting that the repeater 101 can use transfer requests as well as transfer completion notifications for forwarding data between the host 100 and the device 102. The WUSB Repeater Control Driver 803 is responsible for handling data forward control operations, for example, to support data transfer requests from the WUSB Client Device Driver 802. Moreover, the WUSB Repeater Control Driver 803 is also adapted to provide additional software interface functions for the WUSB Repeater Application Software 801 to configure and control the repeater 101. The WUSB Repeater Application Software 801 is an application program which provides user interfaces for controlling and configuring the repeater.

As depicted in FIG. 8, the WUSB Repeater Application Software 801 operates in the application level, while the WUSB Client Device Driver 802, the WUSB Repeater Control Driver 803, and the WUSB Host Control Driver 804 are all running inside the system kernel.

Similar to the loading of a WUSB device driver onto a WUSB host in a host and device arrangement of a conventional WUSB environment, the WUSB Repeater Control Driver 803 of the repeater is loaded to the host software system by the WUSB Host Control Driver 804 after completion of operation step 504. At this instant, the WUSB repeater will be recognized by the host as a WUSB device.

After that, the WUSB Repeater Control Driver 803 will work with the WUSB Host Control Driver 804 to communicate with the repeater 101. The loading of the WUSB Repeater Control Driver is performed by the system kernel function, like, for example, the plug and play manager in the Windows® system. As an alternative implementation scheme, the WUSB Repeater Control Driver 803 can be set to be in constant connection with the WUSB Host Control Driver 804 after its installation. As a further example, the WUSB Repeater Control Driver 803 can include an option whereby a user can disable its function via the WUSB Repeater Application Software. Upon disabling, the WUSB Repeater Control Driver 803 will become a dummy function and the WUSB Client Device Driver 802 will then talk to the WUSB Host Control Driver 804 directly and communicate with the device 102 via the host controller hardware with no repeater function involved, since the host and the device are already mutually recognized.

It will be appreciated from the description above that the repeater of this invention comprises at least one WUSB compatible device, and therefore, the repeater supports at least one WUSB standard compatible association methods. In addition, the repeater also provides means for a WUSB compatible host to perform standard numeric association with a WUSB compatible device indirectly. For brevity, this indirect numeric association will be referred to below as “remote numeric association”. Details of the numeric association are described in the documentation entitled “Association Models Supplement to the Certified Wireless Universal Serial Bus Specification (Revision 1.0) published 2 Mar. 2006, which is incorporated herein by reference.

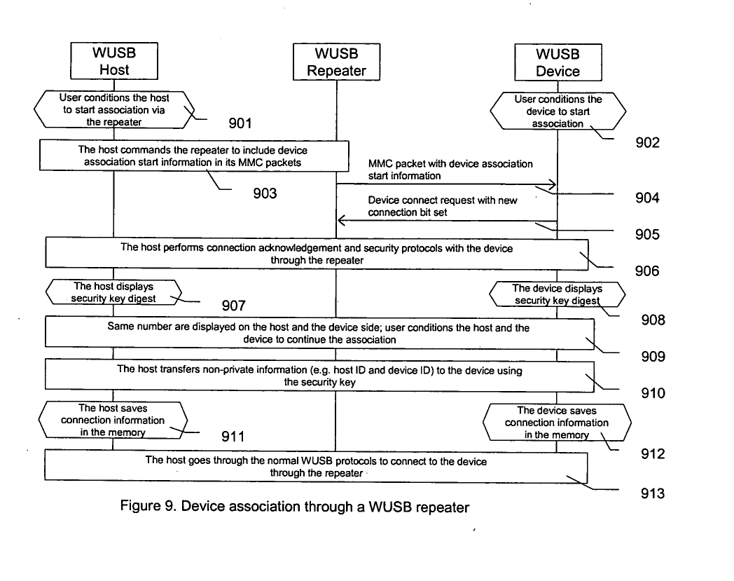

An exemplary set of remote numeric association between a WUSB host and a WUSB device through a WUSB repeater of this invention will be described below with reference to FIGS. 1 and 9. In the description below, a preferred embodiment relating to the selection of one desired repeater from a plurality of repeaters will be described.

Assuming that the repeater 101 has been associated with the host 100 previously but the device 102 is new to the host 100. To associate the repeater 101 with the device 102, it is necessary to condition the host 100 in order to start association via the repeater 101, as depicted in operation step 901. The WUSB Repeater Application Software 801 in the host software system would provide means for a user to command the host 100 to start association on the desired repeater. In particular, the user is required to select which repeater and via which means to establish association.

Initially, the host 100 will send a control request to the repeater 101 so that device association start information is included in its MMC packets (see operation 903). Next, the device 102 is conditioned to start the association process (operation step 902). Of course, it will be appreciated that operation step 902 can be finished before operation step 901. Upon completion of operation step 902, the device 102 will start listening on a physical channel PHY until it has received a MMC packet 904 from the repeater 101. With the received device association start information which is contained in the MMC packet 904, the device 102 will follow the standard WUSB numeric association procedures and send out a device connect request with a new connection bit set within the time interval specified by the MMC packet 904. Similar to the operation 602 described above, the repeater 101 will send a device connect notification to the host 100. Upon detection of the presence of a new device by the host 100, the host 100 will start to go through standard connection acknowledgement and security protocols with the device 102 through the repeater 101 (see operation step 906). The exchange of control requests and results between the host 100 and the device 102 can be achieved using the transfer request control operations described in FIG. 7.

After operation step 906 has been completed, the host 100 and the device 102 will have obtained the security information necessary for establishing a secure connection between them. The security key digest will be displayed and a user can examine if they are the same. Of course, the checking can be performed by electronic or software means. If the security key digests are correct, the host 100 and the device 102 will be conditioned to continue the association process (operation 909). The host 100 will then transfer non-private information (e.g. host ID and device ID) to the device 102 using, for example, the assigned security key (operation 910). Afterwards, the related connection information will be saved in their respective local memories (operations 911 and 912). Finally, the host 100 will go through the normal WUSB protocols (as described in operation 606) to connect the device 102. The device 102 is now associated with the host 100 via the repeater 101 and can communicate with it afterwards.

It will be appreciated that, throughout the data forwarding operations described above, the repeater 101 does not need to know the contents of the forwarded packets and the corresponding security key. Thus, operation of the repeater does not require modifications on the existing WUSB security framework.

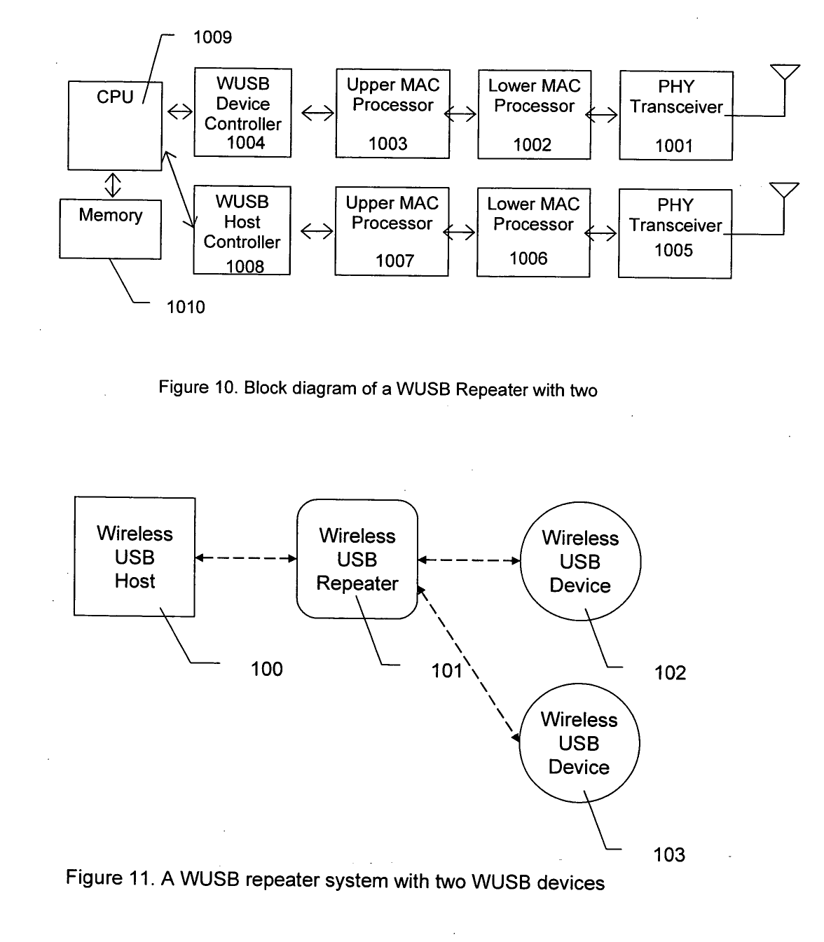

In addition to the single transceiver architecture presented in FIG. 2, the said WUSB repeater can be implemented with two transceiver units as shown in FIG. 10. In this case, the repeater comprises two sets of Upper MAC processors, lower MAC processors and PHY transceivers. The PHY Transceiver 1001, the Lower MAC Processor 1002 and the Upper MAC Processor 1003 are connected to the WUSB Device Controller 1004. They are responsible for handling the WUSB data transfers on the endpoints of the repeater. The PHY Transceiver 1005, the Lower MAC Processor 1006, the Upper MAC Processor 1007 are connected to the WUSB Host Controller 1008 and are responsible for handling the data communications between the repeater and the device. Like the former case, the WUSB Device Controller 1004 and the WUSB Host Controller 1008 interface the CPU 1009 for performing the said repeater functions.

The CPU, the WUSB Device Controller, the WUSB Host Controller and the Upper MAC Processors of FIG. 2 and FIG. 10, can be implemented on a single chip.

The WUSB repeater of this invention can be connected to more than one device, so that communications can be facilitated between a plurality of devices and the WUSB host, as described below with reference to FIG. 11. In the WUSB system of FIG. 11, the host 100 is in connection and communication with the device 102 and 103 through the repeater 101. The connection and association procedure between the host 100 and the device 102 and 103 are identical to that described above.

Specifically, the device 102 includes three endpoints, with the addresses EP_x, EP_y and EP_z. On the other hand, the device 103 has four endpoints, with addresses EP_a, EP_b, EP_c and EP_d. In this application, the repeater 101 will assign a total of seven logical buffer queues, namely, L_{—}0, L_{—}1, L_{—}2, L_{—}3, L_{—}4, L_{—}5, L_{—}6, where
L_{—}0 is for handling data transfers on endpoint EP_x on device 102;
L_{—}1 is for handling data transfers on endpoint EP_y on device 102;
L_{—}2 is for handling data transfers on endpoint EP_z on device 102;
L_{—}3 is for handling data transfers on endpoint EP_a on device 103;
L_{—}4 is for handling data transfers on endpoint EP_b on device 103;
L_{—}5 is for handling data transfers on endpoint EP_c on device 103;
L_{—}6 is for handling data transfers on endpoint EP_d on device 103.

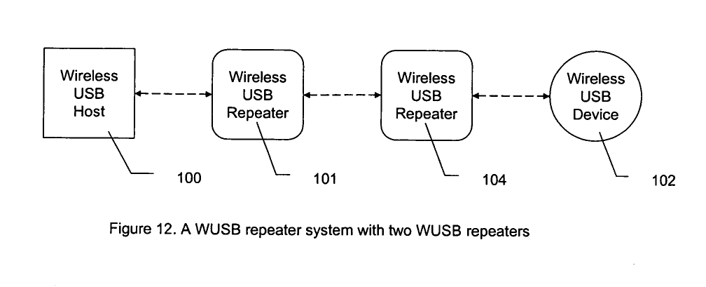

These logical queues are managed in the same manner as when a single device is connected to the repeater described above. The total number of WUSB devices that can be connected to a repeater is limited by the number of the logical queues supported by the repeater. Moreover, the WUSB repeaters of this invention can be connected in cascade between the host and the device, as depicted in FIG. 12, in which the WUSB system comprises two WUSB repeaters in cascade. In this case, the host 100 is connected with the device 102, via repeaters 101 and 104.

To set up a communication link between the host 100 and the device 102, the host 100 will connect with the repeater 101 first, following the operations described above, especially with reference to FIG. 5. Next, the host 100 will connect the repeater 104 through the repeater 101, again, following the procedures described with reference to FIG. 6, and regarding the repeater 104 as a WUSB device. Similarly, the host 100 will connect the device 102 through the repeaters 101 and 104, again following the same operations described with reference to FIG. 6. To communicate with the device 102, the host 100 will first send a transfer request to the bulk OUT endpoint of the repeater 101 in order to set up a logical queue L_x on the repeater 101 for the bulk OUT endpoint of the repeater 104. Next, the host 100 will go through operation steps 701, 702, 703, 704, 705, 706 and 707 to send another transfer request via the logical link L_x to the bulk OUT endpoint of the repeater 104 and then to cause the repeater 104 to set up a new logical queue L_y, in order to handle coming packet transfers to the control endpoint of the device 102. The host 100 can then transfer packets to the device 102 by running the operation steps 701-707 recursively on the repeater 101 and 104 respectively. Next, the repeater will poll the device from time to time according to its endpoint characteristics in order to check if it has data to send to the host. If the repeater 104 has received a data packet from the device 102 after sending a transfer poll on it, it will perform the operation steps 709, 710, 711, 712 and 713 to forward the packet to the repeater 101. Similarly, the repeater 101 will perform the same set of procedures to forward the data it has received from the repeater 104 to the host 100. By utilising this two-way communication path, the host 100 can perform all the operations as described with reference to FIG. 6 to connect and communicate with the device 102.

### Frame Format of a Typical WUSB Packet

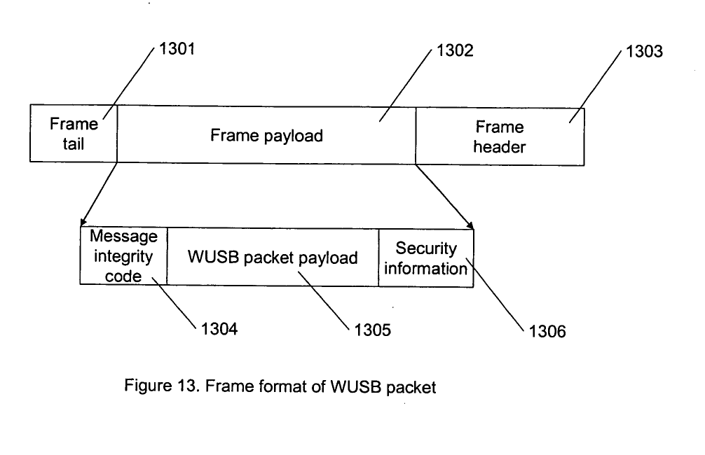

A typical WUSB packet is depicted in FIG. 13. The WUSB packet comprises the following main components, a) frame header 1303, b) frame payload 1302, and c) frame tail 1301. The frame payload 1302 can be further divided into the following parts: i) Security Information 1306, ii) WUSB packet payload 1305, and iii) Message Integrity Code (MIC) 1304.

More particularly, the Security Information 1306 contains keying material, freshness values, and encryption mode information. The WUSB packet payload 1305 contains WUSB protocol data and status information. The Message Integrity Code (MIC) 1304 is an integrity value, which is generated by computing the whole WUSB packet load using an encryption key assigned for the authenticated host to communicate with the authenticated device (which is the destination or source of the frame). The MIC is used by the receiver to check if the WUSB packet payload has been modified by any unauthorized party. Similar to conventional systems, the Security Information 1306 immediately precedes the encrypted data (which is the WUSB Packet Payload 1305). The MIC 1304 field immediately follows the encrypted data. The WUSB Packet Payload 1305 can be encrypted or un-encrypted, depending on the control value setting in the Security Information 1306. A WUSB data packet is said to be in secure encapsulation if the frame containing it has the security information 1306 and the MIC 1304.

In typical WUSB systems, communications between the host and the device are encrypted using keys which are possessed only by the authenticated host and authenticated device. The host maintains a separate or individual key for each connected device. The host then uses an individual key to encrypt all data packets (i.e. WUSB packet payload 1305) which are sent to the corresponding device and to decrypt all packets received from that corresponding device. Therefore, frames containing these data packets must have the correct associated Security Information 1306 and the Message Integrity Code 1304.

It is worth noting that the Security Information 1306 and the Message Integrity Code 1304 are not present in the frame payload 1302 in data exchanges occurring during the association and the authentication phases. Specifically, a WUSB Packet Payload 1305 is transferred in plain text, i.e., not encrypted by any encryption key, during the association and the authentication phase. This is because it is during the association phase and the authentication phase that a host assigns and distributes an encryption key to a device. Hence, a device has no key to encrypt or decrypt when data packets are sent to or are received from a host before the association and the authentication phases have completed. Stated simply, all communications between a host and a device are not encrypted during these phases.

### Association and Authentication Through a WUSB Repeater

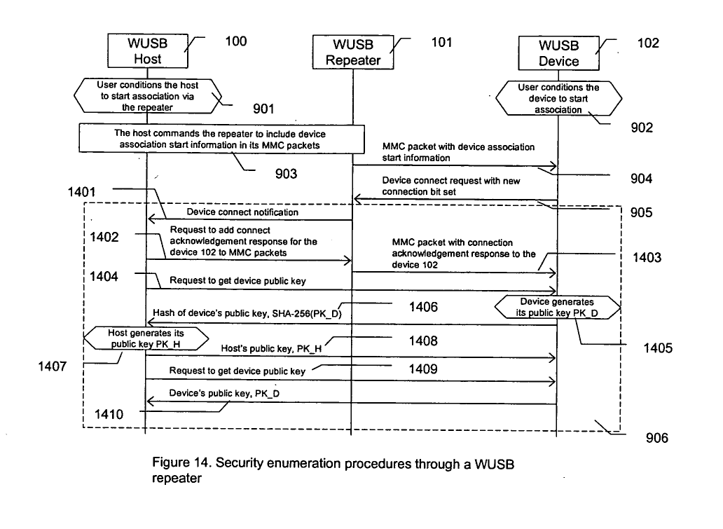

Exemplary steps and/or procedures for performing an exemplary security enumeration phase of the exemplary WUSB repeater system of FIG. 1, comprising a host, a repeater and a new device, are depicted in FIG. 14. In this example, the WUSB repeater 101 is already associated with the host 100 and is in communication therewith. It is assumed that the device 102 is a new device (i.e., not already associated with the host) which is outside the communication range of the host and needs to be associated with the host 100. It is further assumed that the repeater 101 is within the communication range of both the host 100 and the device 102 so that the repeater can “talk”, or communicate, with each of the host and the device directly.

As depicted in FIG. 14, a user has to condition the host 100 and the device 102 in order to initiate association between the host 100 and the device 102. This can be done, for example, by pressing pre-set buttons or other appropriate means designed that purpose on the host and the device, as depicted in operation steps 901, 902. After operation step 901 has completed, the host 100 will send in step 903 a control request to the repeater 101 so that the repeater 101 will include “device association start information” in its MMC packets (say 904).

On the device side, the device 102 will have been set to listen for MMC packets with device association start information after the device has been conditioned in operation 902. After MMC packet 904, which contains the device association start information, has been received by the device 102, the device 102 will send out a device connect request command with a new connection bit set (as depicted in operation step 905).

Upon receipt of the device connect request command from the device 102, the repeater 101 will send a device connect notification 1401 to the host 100. The host 100 will then respond by sending a control request to the repeater 101 to command the repeater to add a connect acknowledgement response for the device 102 in its own MMC packets, as depicted in step 1402. After that, the repeater 101 will generate a MMC packet with connection acknowledgement response to the device 102, as depicted in step 1403. Upon reception of the MMC packet sent in step 1403, the device 102 will configure its address and control settings to make itself ready to go through the upcoming key exchange procedures. After operation step 1402 has completed, the host 100 will send a control request via the repeater 101 to the device 102 to get the public key of the device 102, as depicted in step 1404. Delivery of the request over the repeater 101 as depicted in step 1404 is performed in the manner as depicted in FIG. 7 and described above.

In the following, it will be appreciated that data transfers between the host 100 and the device 102 through the repeater 101 are conducted in the same manner.

After the device 102 has received the request of step 1404 to provide a public key, it will generate a random number (“A”) and use the random number to compute a public key PK_D. The public key can be generated by, for example, using the Diffie-Hellman Key Agreement Method, as described in [RFC2631], or other appropriate key generation methods or algorithms known from time to time. Next, the device 102 will compute the hash value of the public key PK_D, which is conveniently denoted as SHA-256(PK_D). The hash value can be computed using, for example, the SHA-256 algorithm, which is a variant of the SHA algorithm which produces a 256-bit message digest as described in [FIPS180-2: Secure Hash Standard], or other appropriate hash computation methods or algorithms known from time to time.

Next, in step 1406, the device 102 will send the hash SHA-256(PK_D) to the host 100 through the repeater 101. In response, the host 100 will generate in step 1407 another random number (“B”) and the random number B will be used to generate an own public key PK_H of the repeater. Similarly, the public key PK_H of the repeater cab be generated by using the Diffie-Hellman Key Agreement Method or other appropriate methods. In step 1408, the host 100 will send the public key PK_H to the device 102 and via the repeater 101. Next, and in step 1409, the host 100 will send a control request to the device 102 to get the public key of the device. In response, the device 102 will send its own public key PK_D to the host 101, as depicted in step 1410. Upon completion of the above procedures, public keys of the host 100 and the device 102 are exchanged via the repeater 101. It will be appreciated that operation steps 1401 to 1410 are expanded from the operation step 906 of FIG. 9. Thus, all data transfers between the host 100 and the repeater 101 as depicted in FIG. 14 are protected with encryption keys possessed respectively by the host 100 and the repeater 101. In other words, each WUSB payload 1305 in a data frame is encrypted, and security information 1306 and message integrity code 1304 are both present in the frame payload 1302.

It will be appreciated that as the association and the authentication steps have not been performed, the host 100 and the device 102 are not yet associated at this stage. As no keys are available for encrypting and decrypting data before data transfers take place between the host and the device, data frames transferred between the repeater 101 and the device 102 are not encrypted. Therefore, WUSB packet payloads 1305 are in un-encrypted plain text, and no security information 1306 nor MIC 1304 are present in the frame payload 1302.

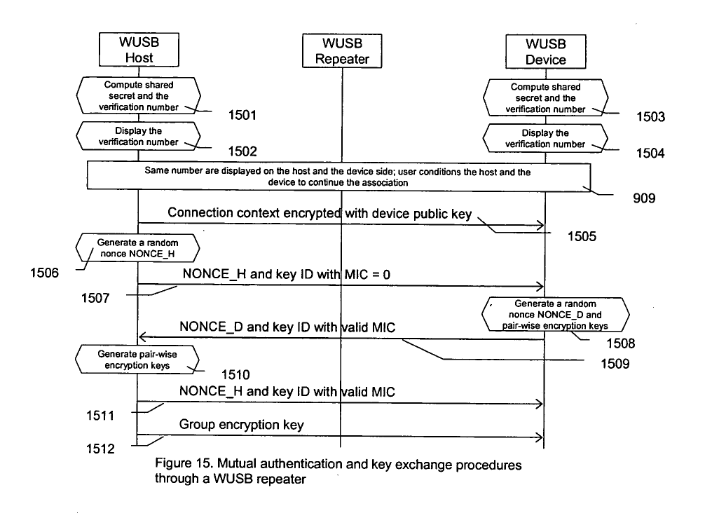

An exemplary manner in which the host 100 and the device are mutually authenticated with connection keys exchanged via the repeater 101 will be described in more detail below with reference to FIG. 15.

After the public key exchange as described with reference to FIG. 14 has be completed, the host 100 and the device 102 will have obtained the public key of each other. Specifically, the host 100 will have acquired the public key of the device, namely, PK_D, and the device 102 will have acquired the public key of the host, namely, PK_H. A shared secret key, namely, DH_KEY, is then derived from the received public keys, namely, PK_{–}D or PK_H, and their respective own random number A and B, by using the same hash algorithm, namely, the SHA-256 algorithm.

Based on the shared secret key, DH_KEY, the host 100 will compute in step 1501 a verification number V_H. The verification number can be computed by, for example, using a keyed-hash message authentication code (HMAC) or other appropriate authentication schemes or algorithms, together with the hash function SHA-256. Details of HMAC are described in [RFC2104: HMAC: Keyed-Hashing for Message Authentication] and are incorporated herein. In step 1502, the verification number has been obtained and the host will cause the verification number V_H to be output for display on a VDU (video display unit), for example, a LED video display. The device 102 will compute its own verification number, namely, V_D, in a similar manner in step 1503 and then output the verification number on its own video display, as depicted in step 1504. Since the host 100 and the device 102 have the same shared secret key DH_KEY, the verification number derived by them should be identical.

After the verification numbers V_H and V_D displayed respectively on the host 100 and the device 102 have been confirmed to be identical, compatible or matched, the user will then proceed to condition the host 100 and the device 102, and then to continue with the remaining key exchange process, as depicted in step 909. After operation step 909 has been completed, the host 100 will send out a connection context to the device 102 via the repeater 101, as more particularly depicted in step 1505. The connection context contains non-private information, such as the host connection ID and the device connection ID, which is assigned by the host 100. Next, the host 100 will generate a random nonce, namely, NONCE_H, in step 1506, and will then send the random nonce to the device 102 together with a key identity (key ID) information as well as a zero value of the message integrity code (MIC) field in the WUSB packet payload 1305. It will be noted that this MIC field is inside the WUSB packet payload 1305, which is different from the one 1304 present in the frame payload 1302 of FIG. 13.

Upon receipt of NONCE_H from the packet in step 1507, the device 102 will respond by generating another random nonce, namely, NONCE_D. Next, in step 1508, the device will use the random nonce, NONCE_H and NONCE_D, to compute two separate keys, namely, pair-wise key and confirmation key, based on the shared secret derived in operation step 1503. The device 102 will then use the confirmation key to compute the message integrity code (MIC) for the data field containing the NONCE_D and the key identity (Key ID) information received from the host 100. After that, the device will place the NONCE_D, the Key ID and the resultant MIC field inside the same WUSB data payload 1305 and send the MIC field to the host 100 via the repeater 101, as depicted in operation step 1509. After operation step 1509, the host will have received the WUSB data payload packet 1305. Next, the host 100 will obtain the random nonce NONCE_D and will use it together with the random nonce, namely, NONCE_H, to generate the same pair-wise key and confirmation key, in the same manner as the pair-wise key and confirmation key have been generated by the device 102, and based on the shared secret derived in operation step 1501.

The host 100 will then use the confirmation key to compute the MIC for the data field containing the NONCE_D and the key ID and to check if the generated MIC is equal to the MIC contained in the payload packet obtained in operation step 1509.

If the test result is yes (or positive), the host 100 will send out the NONCE_H and the key ID to the device 102 again, but this time also with the MIC generated for these two fields using the confirmation key derived in operation step 1510. In this case, after the packet sent in step 1511 has been received, the device 102 will check if the MIC contained in the packet received in step 1511 is equal to the one generated for the NONCE_H and key ID fields using its own confirmation key. If the result is yes (or positive), the device 102 will install the pair-wise key it has derived before (in operation step 1503). In such a case, the pair-wise key is ready to be used for decrypting all the data packets received from the host 100 and to encrypt all data packets to be sent to the host 100, via the repeater 101. Therefore, the communications between the host 100 (via the repeater 101) and the device 102 are all in data packets with the WUSB packet payload encrypted, with the MIC and security information present in their corresponding frame payload.

On the other hand, if the host 100 or the device 102 fails to generate a MIC which is matched, i.e., identical or compatible, to the received one, the key exchange process will be aborted and the authentication process declared failed.

The pair-wise key described above is for enabling secured, point-to-point, data communications between the host and the device. In addition, the host also has a group encryption key to protect broadcast communication, for example, the transmission of MMC packets from the host to every device in the same WUSB system. The group encryption key is created by the host and will be distributed to the device upon successful association of the device 102, that is after the pair-wise key exchange procedures (operation steps 1506 to 1511) have been completed and the device 102 authenticated. Specifically, the host 100 will deliver the group encryption key to the device 102 via the repeater 101, as depicted in operation step 1512. Similar to what were depicted in FIG. 14, all communications between the host 100 and the repeater 101 are in secured frames. More particularly, each of the secure frames containing the MIC field 1304, the security information 1306 and the WUSB packet payloads 1305 are encrypted.

On the other hand, the communications steps 1505, 1507 1509 and 1511 between the repeater 101 and the device 102 are unsecured. This means all the data frames which are transferred between the repeater 101 and the device 102 in those steps do not contain the security information 1306 and MIC 1304 in the frame payload 1302, and the WUSB packet payloads 1305 are transferred in plain text, not encrypted.

After the device 102 has successfully validated the MIC received in operation step 1511, the device 102 is ready to begin communication with the host 100 via the repeater using the derived encryption key. Subsequently, when the host 100 wishes to send a data packet, say packet A, to the device 102, it will first encrypt the data packet (packet A) using the key assigned for communications with the repeater 101 and then send the encrypted packet A to the repeater 101, following the forwarding mechanism as described with reference to FIG. 7. Upon receiving packet A, the repeater 101 will decrypt packet A and then deliver it to a logical buffer in the repeater, which has been assigned for communications with the device 102. When the repeater 101 is ready to forward the packet A to the device 102, the repeater 101 will retrieve the packet A from its logical buffer and encrypt it using the pair-wise key derived in operation steps 1508 to 1510 to prepare for onward transmission to the device 102. Next, the repeater 101 will send the encrypted packet A to the device 102. The packet A will be decrypted at device 102 by using the pair-wise key derived in operation step 1508 and upon suitable processing. Since the host 100 will have informed the repeater 101 of the necessary keying information during the transfer requests for handling data forwarding to the device 102, the repeater 101 would have acquired the necessary information for encrypting and/or decrypting data packets sent to and received from the endpoints on the device 102. It will be appreciated that the encryption algorithms, including the secure hash algorithm and key agreement method, described above are only for illustrations only and are defined by the WUSB standards.

While the present invention has been explained by reference to the examples or preferred embodiments described above, it will be appreciated that those are examples to assist understanding of the present invention and are not meant to be restrictive. Variations or modifications which are obvious or trivial to persons skilled in the art, as well as improvements made thereon, should be considered as equivalents of this invention.

Furthermore, while the present invention has been explained by reference to a repeater for WUSB applications, it should be appreciated that the invention can apply, whether with or without modification, to other repeater applications without loss of generality.

1. A repeater for connecting a host and a device in a WUSB environment, the repeater comprising:
host interfacing means for establishing a secure wireless data communication channel for data communication with a host,
device interfacing means for establishing a secure wireless data communication channel for data communication with a device,
data buffer for storing data for subsequent onward transmission to either said host or said device, and
scheduler for scheduling timing of onward transmission of data from said data buffer to either said host or said device.

2. A repeater according to claim 1, wherein scheduling information on timing of onward transmission from said buffer to either said host or said device is contained in data received through said.host interfacing means.

3. A repeater according to claim 1, further comprising a control means for onward transmission of data to said host or said device.

4. A repeater according to claim 3, wherein said data comprises host identification information of said host.

5. A repeater according to claim 2, wherein said repeater comprises a transceiver means for operating on a plurality of physical channels, said scheduling information on timing of onward transmission from said buffer to either said host or said device is contained in data received through said host interfacing means.

6. A repeater according to claim 1, wherein said scheduler comprises means for reserving a first set of time slots for data communication between said repeater and said host, and for reserving a second set of time slots for data communication between said repeater and said device, the time slots in said first and second sets of time slots being overlapping.

7. A repeater according to claim 1, wherein said scheduler comprises means for reserving a first set of time slots for data communication between said repeater and said host, and for reserving a second set of time slots for data communication between said repeater and said device, the time slots in said first and second sets of time slots being non-overlapping.

8. A repeater according to claim 7, wherein said first and said second set of time slots are within a same superframe.

9. A repeater according to claim 1, wherein said host interfacing means is configured to communicate as a device for establishing a communication link with said host.

10. A repeater according to claim 1, wherein said device interfacing means is configured to communicate as a host for establishing a communication link with said device.

11. A repeater according to claim 1, wherein said repeater is configured to communicate as a device for establishing a communication link with said host, and said repeater is configured to communicate as a host for establishing a communication link with said device.

12. A repeater according to claim 1, wherein said host interfacing means comprises a wireless transceiver operable on a plurality of physical channels, said wireless transceiver operating in a single physical channel for establishing a communication link with said host.

13. A repeater according to claim 12, wherein said host interfacing means is configured to respond to polling of said host by transmitting a data packet on said single physical channel.

14. A repeater according to claim 1, wherein said device interfacing means comprises a wireless transceiver operable on a plurality of physical channels, said wireless transceiver operating on a single physical channel when establishing a communication link with said device.

15. A repeater according to claim 1, wherein said device interfacing means is adapted for connection with a plurality of devices.

16. A repeater according to claim 1, wherein said repeater further comprises means for uploading control data to said host, said control data are utilized by said host for controlling said repeater for data communication with said device.

17. A WUSB system comprising a host, a device and at least one repeater as claimed in claim 1.

18. A WUSB system according to claim 17, wherein scheduling information on timing of onward transmission from said buffer to either said host or said device is contained in data received through said host interfacing means.

19. A WUSB system according to claim 17, further comprising a control means for onward transmission of data to said host or said device.

20. A WUSB system according to claim 19, wherein said data comprises host identification information of said host.

21. A WUSB system according to claim 18, wherein said repeater comprises a transceiver means for operating on a plurality of physical channels, said scheduling information on timing of onward transmission from said buffer to either said host or said device is contained in data received through said host interfacing means.

22. A WUSB system according to claim 17, wherein said scheduler comprises means for reserving a first set of time slots for data communication between said repeater and said host, and for reserving a second set of time slots for data communication between said repeater and said device, the time slots in said first and second sets of time slots being overlapping.

23. A WUSB system according to claim 17, wherein said scheduler comprises means for reserving a first set of time slots for data communication between said repeater and said host, and for reserving a second set of time slots for data communication between said repeater and said device, the time slots in said first and second sets of time slots being non-overlapping.

24. A WUSB system according to claim 23, wherein said first and said second set of time slots are within a same superframe.

25. A WUSB system according to claim 17, wherein said host interfacing means is configured to communicate as a device for establishing a communication link with said host.

26. A WUSB system according to claim 17, wherein said device interfacing means is configured to communicate as a host for establishing a communication link with said device.

27. A WUSB system according to claim 17, wherein said repeater is configured to communicate as a device for establishing a communication link with said host, and said repeater is configured to communicate as a host for establishing a communication link with said device.

28. A WUSB system according to claim 17, wherein said host interfacing means comprises a wireless transceiver operable on a plurality of physical channels, said wireless transceiver operating on a single physical channel when establishing a communication link with said host.

29. A WUSB system according to claim 28, wherein said host interfacing means is configured to respond to polling of said host by transmitting a data packet on said single physical channel.

30. A WUSB system according to claim 17, wherein said device interfacing means comprises a wireless transceiver operable on a plurality of physical channels, said wireless transceiver operating on a single physical channel when establishing a communication link with said device.

31. A WUSB system according to claim 17, wherein said device interfacing means is adapted for connection with a plurality of devices.

32. A WUSB system according to claim 17, wherein said repeater further comprises means for uploading control data to said host, said control data are utilized by said host for controlling said repeater for data communication with said device.

33. A WUSB system comprising a host, a device and a plurality of repeaters of claim 1 connected in cascade.

34. A method for relaying data packets between a host and a device through a repeater in a WUSB environment, the method comprising:
establishing a secured wireless data communication channel for data communication with said repeater and said host,
establishing a secured wireless data communication channel for data communication with said repeater and said device,
storing data in a data buffer of said repeater for subsequent onward transmission to either said host or said device, and
scheduling timing of onward transmission of data from said data buffer to either said host or said device.

35. A method according to claim 34, wherein timing of onward transmission of data from said data buffer to said device is determined from contents of data received through said host interfacing means.

36. A method according to claim 34, wherein an acknowledgement or a handshake signal is sent by said repeater to said host after stored data have been transferred from said repeater to said device.

37. A method according to claim 34, wherein said device is associated with said host through said repeater, association between said host and said device comprises a first association between said host and said repeater, and a second association between said host and said device via said repeater.

38. A method according to claim 37, wherein said repeater is associated as a WUSB device to said host, and said repeater behaves as a WUSB host to associate with said device under control of said host.

39. A method according to claim 34, wherein stored data are transmitted to said data buffer of said repeater upon receipt of a data request instruction of said host by said repeater, said stored data being transferred from said repeater to said host upon a successful polling of said repeater by said host.

40. A method according to claim 34, wherein said repeater transmits an interrupt request to said host after data for forwarding to said host have been stored in said buffer, said data being transferred from said repeater to said host after a successful polling of said repeater by said host.
